(19) United States
(12) Patent Application Publication
(10) Pub. No.: US 2023/0419740 A1
(43) Pub. Date: Dec. 28, 2023

(54) NON-INVASIVE BIOMETRIC SYSTEM AND METHOD FOR ENCODING ANATOMICAL FEATURES AS BIOMETRIC DATA

(71) Applicant: Shanghai United Imaging Intelligence Co., LTD., Shanghai (CN)

(72) Inventors: Benjamin Planche, Cambridge, MA (US); Ziyan Wu, Cambridge, MA (US); Meng Zheng, Cambridge, MA (US); Terrence Chen, Cambridge, MA (US)

(73) Assignee: Shanghai United Imaging Intelligence Co., LTD., Shanghai (CN)

(21) Appl. No.: 17/851,190

(22) Filed: Jun. 28, 2022

(51) Int. Cl. G06V 40/70; G06T 7/00; G06V 40/10

(52) U.S. Cl. CPC G06V 40/70; G06T 7/0012; G06V 40/15; G06T 2207/10088; G06T 2207/10104; G06T 2207/10108; G06T 2207/10116; G06T 2207/10081

(57) ABSTRACT

A non-invasive biometric system includes a processor that is configured to control a scanner, which is configured to scan and capture one or more anatomical images of a body of a target person. The processor is further configured to identify one or more anatomical structures in the captured one or more anatomical images and extract anatomical features for the identified one or more anatomical structures. The processor is further configured to register the extracted anatomical features for the identified one or more identified anatomical structures to a posture and an external appearance of the target person. The processor is further configured to encode and utilize the extracted anatomical features as biometric data, which is unique for the target person, and may be used for authentication of the target person.

### TECHNICAL FIELD

The present disclosure relates generally to the field of non-invasive biometric systems and more specifically, to a non-invasive biometric system and a method for encoding anatomical features as biometric data.

### BACKGROUND

Typically, biometrics are methods for uniquely recognizing humans based upon one or more physical or behavioral traits. Examples of physical biometrics include fingerprinting, iris recognition, face recognition, etc. Examples of the behavioral biometrics include a typing pattern, a mouse movement identification, gait recognition, etc. The choice of one or more biometrics for an application lies on multiple factors. Example of the factors include: (a) Universality (i.e., every target person should possess the measured biometric); (b) Uniqueness (i.e., the measured trait should sufficiently discriminate and distinguish each people in the target population); (c) Permanence (i.e., the quality of the measured biometric to be reasonably invariant over time with respect to a specific matching algorithm); (d) Measurability (i.e., the ease of acquisition or measurement of the trait); (e) Performance (i.e., accuracy, speed, and robustness of technology used); (f) Acceptability (i.e., how well target population accepts the technology); (g) Non-circumvention (i.e., how difficult the biometric can be imitated or substituted). Existing biometric systems and methods either rely on traits relating to external appearance (e.g., fingerprints, iris properties, voice, etc.), which can be detected accurately but at the same time more easily tampered. For example, among other counterfeit technologies, plastic surgery, for example, has made bypassing of some common biometrics relatively easier for ill-motivated individuals. In another example, certain biometrics are robust but harder to collect (e.g., DNA, etc.). Thus, there exists a technical problem of how to develop a non-invasive biometric system that meets all the above factors, without sacrificing on accuracy and ease-of-use.

Further limitations and disadvantages of conventional and traditional approaches will become apparent to one of skill in the art through comparison of such systems with some aspects of the present disclosure as set forth in the remainder of the present application with reference to the drawings.

### SUMMARY

The present disclosure provides a non-invasive biometric system and a method for encoding anatomical features as biometric data, substantially as shown in and/or described in connection with at least one of the figures, as set forth more completely in the claims.

In one aspect, the present disclosure provides a non-invasive biometric system that comprises a processor. The processor is configured to control a scanner configured to scan and capture one or more anatomical images of a body of a target person. The processor is further configured to identify one or more anatomical structures in the captured one or more anatomical images and extract anatomical features for the identified one or more anatomical structures. The processor is further configured to register the extracted anatomical features for the identified one or more anatomical structures to a posture and an external appearance of the target person. The processor is further configured to encode and utilize the extracted anatomical features as biometric data.

In a possible implementation form the feature vector is a discriminative feature vector.

The non-invasive biometric system is used for non-invasive biometric authentication based on imaging of in-vivo body organs. The non-invasive biometric system includes the processor that is used for extraction, and encoding of robust and distinctive anatomical features to obtain utilize the biometric data, which is beneficial to improve the permanence and non-circumvention factors of the non-invasive biometric system. As the biometric data is based on anatomical features, which is unique for each target person, thus the biometric data cannot be tampered, for example, even by plastic surgery or other means. In addition, the disclosed biometric system is non-invasive, accurate, and fail-safe.

It is to be appreciated that all the aforementioned implementation forms can be combined. It has to be noted that all devices, elements, circuitry, units, and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity that performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features, and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1A is a network environment diagram of an exemplary non-invasive biometric system, in accordance with an embodiment of the present disclosure;

FIG. 1B is a block diagram that illustrates various exemplary components of a computing device, in accordance with an embodiment of the present disclosure;

FIG. 2 is a diagram illustrating an exemplary scenario of implementation of an exemplary invasive biometric system, in accordance with an embodiment of the present disclosure; and

FIGS. 3A and 3B collectively is a diagram illustrating a flowchart of a method for encoding anatomical features as biometric data, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates exemplary embodiments of the present disclosure and ways in which they can be implemented. Although some modes of carrying out the present disclosure have been disclosed, those skilled in the art would recognize that other embodiments for carrying out or practicing the present disclosure are also possible.

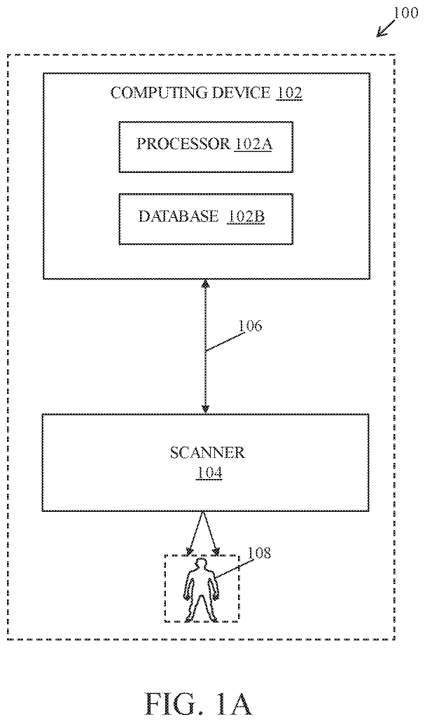

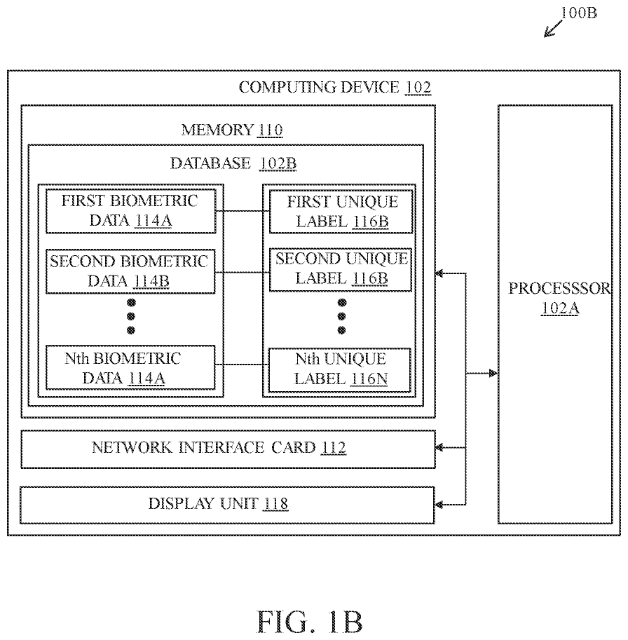

FIG. 1A is a network environment diagram of an exemplary non-invasive biometric system, in accordance with an embodiment of the present disclosure. With reference to FIG. 1A, there is shown a network environment diagram of a non-invasive biometric system 100A that includes a computing device 102, a scanner 104, and a communication network 106. The computing device 102 further includes a processor 102A and a database 102B. There is further shown a target person 108 positioned within a scanning area of the scanner 104.

As is illustrated in the example of FIG. 1A, in one embodiment, the processor 102A of non-invasive biometric system 100A is configured to control the scanner 104 to scan and capture one or more anatomical images of a body of a target person 108. The processor 102A is configured to identify one or more anatomical structures in the captured one or more anatomical images; extract anatomical features for the identified one or more anatomical structures; register the extracted anatomical features for the identified one or more anatomical structures to a posture and an external appearance of the target person; combine the extracted anatomical features into a single feature vector; and encode and store the single feature vector as biometric data. In one embodiment, the feature vectors are discriminative feature vectors.

The non-invasive biometric system 100A corresponds to a biometric authentication system, which is based on, for example, scanning of anatomical images and anatomical feature encoding. The non-invasive biometric system 100A is based on the encoding of discriminative anatomical properties from body scans of the target person 108. The non-invasive biometric system 100A is configured to use a set of non-invasive biometrics based on discriminative inner-body features, such as organs, bones, and the like. In an example, such features can be extracted for authentication from radiographs of the target person 108.

The computing device 102 may include suitable logic, circuitry, interfaces and/or code that is configured to communicate with the scanner 104 via the communication network 106 (e.g., a propagation channel). The computing device 102 includes the processor 102A and the database 102B. Examples of each of the computing device 102 may include but are not limited to, a computer system, a personal digital assistant, a portable computing device, an electronic device, a storage server, a cloud-based server, a web server, an application server, or a combination thereof.

The processor 102A is configured to process an input provided by the scanner 104. The processor 102A is also configured to control the scanner 104 to scan and capture one or more anatomical images of a body of the target person 108. Examples of the processor 102A may include but are not limited to, a processor, a digital signal processor (DSP), a microprocessor, a microcontroller, a complex instruction set computing (CISC) processor, an application-specific integrated circuit (ASIC) processor, a reduced instruction set (RISC) processor, a very long instruction word (VLIW) processor, a state machine, a data processing unit, a graphics processing unit (GPU), and other processors or control circuitry.

The database 102B may store biometric data. Moreover, the scanner 104 may include suitable logic, circuitry, interfaces, or code that is configured to scan and capture one or more anatomical images of the body of the target person 108. In an implementation, the scanner 104 corresponds to a X-ray scanner that is used for anatomical feature encoding. Examples of the scanner 104 may include but are not limited to a computed tomography (CT) scanner, a magnetic resonance imaging (MRI) scanner, a positron emission tomography (PET) scanner, an ultrasound scanner, a single-photon emission computerized tomography (SPECT) scanner, or other medical imaging modality. However, other scanners can also be used without limiting the scope of the invention, provided that such scanners are also configured to scan and capture one or more anatomical images of the body of the target person 108.

The communication network 106 includes a medium (e.g., a communication channel) through which the computing device 102, potentially communicates with the scanner 104. Examples of the communication network 106 may include, but are not limited to, a cellular network, a wireless sensor network (WSN), a cloud network, a Local Area Network (LAN), a Metropolitan Area Network (MAN), and/or the Internet.

Beneficially, the non-invasive biometric system 100A is used for non-invasive biometric authentication based on imaging of in-vivo body organs. The non-invasive biometric system 100A meets various factors, such as Universality, Uniqueness, Permanence, Measurability, Performance, Acceptability, and Non-circumvention without sacrificing on accuracy and ease-of-use.

FIG. 1B is a block diagram of a computing device, in accordance with an embodiment of the present disclosure. With reference to FIG. 1B, there is shown a block diagram 100B of the computing device 102 that includes a memory 110, a network interface 112, and a display unit 118. The memory 110 further includes the database 102B of FIG. 1A. The memory 110 is configured to store biometric data, such as a first biometric data 114A, a second biometric data 114B up to an Nth biometric data 114N. There is further shown a plurality of unique labels, such as a first unique label 116A, a second unique label 116B up to an Nth unique label 116N. There is further shown the processor 102A and the database 102B.

The memory 110 may include suitable logic, circuitry, interfaces, or code that is configured to store anatomical features as the biometric data, such as to store the first biometric data 114A, the second biometric data 114B up to the Nth biometric data 114N. In an implementation, the memory 110 corresponds to a local memory, such as an Electrically Erasable Programmable Read-Only Memory (EEPROM), Random Access Memory (RAM), Read-Only Memory (ROM), a central processing unit (CPU) cache memory, and the like.

The network interface 112 includes hardware or software that is configured to establish communication between the computing device 102 and the scanner 104 through the communication network 106 of FIG. 1A. Examples of the network interface 112 may include but are not limited to, a computer port, a network socket, a network interface controller (NIC), and any other network interface device. Moreover, the display unit 118 is used to display a subset of visual features and positioning features that belong to the one or more anatomical structures of the target person 108.

There is provided the non-invasive biometric system 100A that includes the processor 102A. The processor 102A may be configured to control the scanner 104, which is used to scan and capture one or more anatomical images of the body of the target person 108 (of FIG. 1A). The processor 102A may be configured to control the scanner 104 to capture the one or more anatomical images of the body of the target person 108. In an implementation, the one or more anatomical images of the body of the target person 108 that are captured by scanner 104 may be visible on the display unit 118 of the computing device. In an implementation, the scanner 104 corresponds to a X-ray scanner that is configured to pass X-rays through the body of the target person 108, and then detect the passed X-rays. In accordance with an embodiment, the scanner 104 may be at least one of a computed tomography (CT) scanner, a magnetic resonance imaging (MRI) scanner, a positron emission tomography (PET) scanner, an ultrasound scanner, a single-photon emission computerized tomography (SPECT) scanner, or other medical imaging modality. Therefore, the scanner 104 may be configured to capture the one or more anatomical images of the body of the target person 108 based on the type of the scanner 104. In an implementation, the one or more anatomical images allow a medical personnel to view inside the body of the target person 108 without any risk of exploratory surgery. In an example, the scanner 104 may be configured to capture cross-sectional images (or tomographic images) of the body of the target person 108. In another example, the scanner 104 may be configured to capture three-dimensional images of the body of the target person 108.

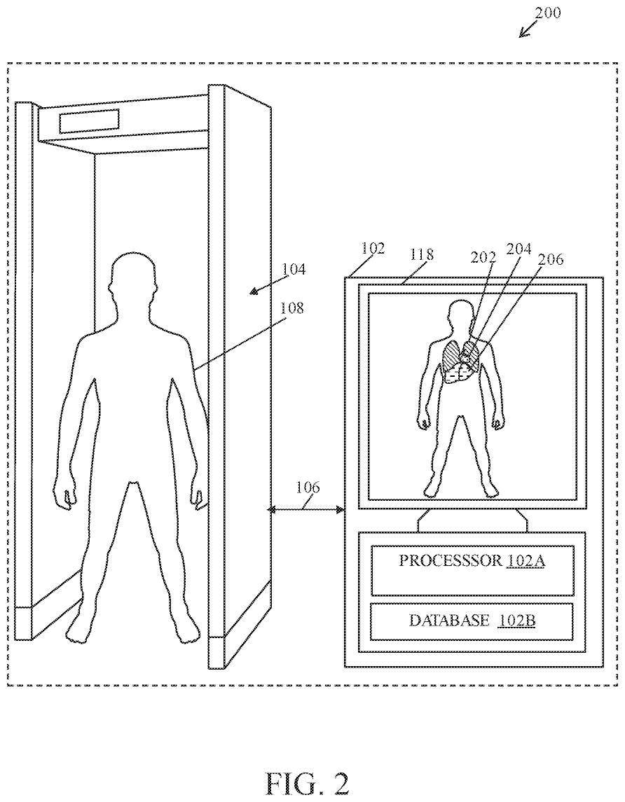

The processor 102A may further be configured to identify one or more anatomical structures in the captured one or more anatomical images. Firstly, the processor 102A may be configured to receive the captured one or more anatomical images, then the processor 102A may be configured to identify the one or more anatomical structures in the captured one or more anatomical images. In an example, the identified one or more anatomical structures are also visible on the display unit 118 of the computing device 102, as further shown and described in FIG. 2. In accordance with an embodiment, the identified one or more anatomical structures may be at least one of a single organ, a set of organs, a single bone, a set of bones, a liver, a spleen, or a combination of body organs and bones. Moreover, the processor 102A may be configured to extract the anatomical features for the identified one or more anatomical structures. In an example, the extracted anatomical features correspond to heartbeat, condition of the liver (e.g., stretch/compressed or affected), shape and size of bone marrow, and the like. However, the extracted anatomical features may correspond to other features without limiting the scope of the invention.

The processor 102A may further be configured to register the extracted anatomical features for the identified one or more anatomical structures to a posture and an external appearance of the target person 108. In an implementation, the processor 102A may be configured to register the extracted anatomical features in a robust manner (i.e., robust to organ stretch or organ compression). Moreover, the extracted anatomical features may be registered to the posture and the external appearance of the target person 108, which is unique for the target person 108. In an example, the posture of the target person 108 may correspond to a position in which the target person 108 is standing, sitting, or lying down on a floor or a bed. In another example, the external appearance of the target person 108 may correspond to the outward phenotype or look of the target person 108. In accordance with an embodiment, the processor 102A may be configured to combine the extracted anatomical features into one or more discriminative feature vectors. In an implementation, the extracted anatomical features are obtained from multiple scan results of the scanner 104 for the target person 108. Moreover, the processor 102A may be configured to detect and extract any salient anatomical structures from the multiple scan result. Thereafter, the processor 102A may be configured to combine all the extracted anatomical features into the one or more discriminative feature vectors for the target person 108. As a result, the one or more discriminative feature vectors are unique for the target person 108 and is also different from the discriminative feature vector of other target persons.

The processor 102A may further encode and utilize the extracted anatomical features as biometric data. In an implementation, the processor 102A may be configured to use an encoding algorithm to encode the extracted anatomical features as the biometric data. Furthermore, the processor 102A may be configured to utilize the extracted anatomical features as the biometric data. Thereafter, the processor 102A may be configured to store the extracted anatomical features as the biometric data in the database 102B of the memory 110 of the computing device 102. In accordance with an embodiment, the processor 102A may further be configured to combine the extracted anatomical features of the identified one or more anatomical structures into the biometric data. In such embodiment, the processor 102A may be configured to encode the identified one or more anatomical structures, as well as the position of each anatomical structure with respect to other anatomical structures from the identified one or more anatomical structures.

In accordance with an embodiment, the processor 102A may further be configured to assign a unique label to the biometric data, and the unique label is indicative of the target person 108. In an implementation, the first biometric data 114A may include the one or more discriminative feature vectors of the identified one or more anatomical structures for the target person 108. Moreover, the processor 102A may further be configured to assign the first unique label 116A to the first biometric data 114A, such as the first unique label 116A is indicative of the target person 108. In addition, the first unique label 116A is also used as an identity of the target person 108, because the first unique label 116A is distinctive for the target person 108. The first unique label 116A assigned to the first biometric data 114A may be used for authentication of the target person 108. Similarly, the second unique label 116B may be assigned to the second biometric data 114B that corresponds to a second target person, and the Nth unique label 116N may be assigned to the Nth biometric data 114N that corresponds to the Nth target person. In accordance with an embodiment, the processor 102A may further be configured to store the biometric data along with the unique label in the memory 110. As a result, the biometric data along with the unique label stored with the memory 110 may be used for later comparison, such as at the registration stage (or at the authentication stage) of the target person 108. In accordance with an embodiment, the processor 102A may further be configured to combine the extracted anatomical features with other biometric data of the target person 108. In an example, the other biometric data of the target person 108 may include color images of the target person 108 that can be captured along with the scans and processed to extract facial features. As a result, the extracted anatomical features, as well as other biometric data of the target person 108, may be used collectively for authentication of the target person. In an implementation, the processor 102A may be configured to use each anatomical feature separately for identification of the target person.

In accordance with an embodiment, the processor 102A may further be configured to execute a query of the one or more discriminative feature vectors against the database 102B that includes a number of prestored discriminative feature vectors for authentication of the target person 108. The number of prestored discriminative feature vectors are obtained and stored by the processor 102A. In an example, the number of prestored discriminative feature vectors corresponds to a number of discriminative feature vectors that are obtained after scanning a plurality of target persons. In an implementation, the number of prestored discriminative feature vectors may include a subset of visual features and positioning features that belong to the one or more anatomical structures encoded into the one or more discriminative feature vectors. In such embodiment, the processor 102A may further be configured to match at least two discriminative feature vectors in the database 102B by comparing a subset of visual features and positioning features that belong to the one or more anatomical structures encoded into the biometric data for the authentication of the target person 108. The processor 102A may be configured to execute the algorithm to compare the subset of visual features, the positioning features of the one or more discriminative feature vectors with the subset of visual features, and the positioning features of another discriminative feature vector. In an example, if the subset of visual features and the positioning features of the one or more discriminative feature vectors is the same as that of the subset of visual features, and the positioning features of another discriminative feature vector, then the at least two discriminative feature vectors are matched, otherwise not. As a result, the matching of the at least two discriminative feature vectors in the database 102B may be used by the processor 102A of the non-invasive biometric system 100A for authentication and verification of the target person 108 at different security checkpoints (e.g., in airports, official buildings) with improved accuracy, speed, and robustness.

The non-invasive biometric system 100A may be used for non-invasive biometric authentication based on imaging of in-vivo body organs. The processor 102A of the non-invasive biometric system 100A may be used for extraction and encoding of robust and distinctive anatomical features to obtain and utilize the biometric data, which is beneficial to improve the permanence and non-circumvention factors of the non-invasive biometric system 100A. As the biometric data is based on anatomical features, which is unique to each target person, thus the biometric data cannot be altered, for example, even by plastic surgery or other means. In addition, the non-invasive biometric system 100A is accurate, and fail-safe. The non-invasive biometric system 100A further meets various factors, such as Universality, Uniqueness, Permanence, Measurability, Performance, Acceptability, and Non-circumvention without sacrificing on accuracy and ease-of-use.

FIG. 2 is a diagram illustrating an exemplary scenario of implementation of an exemplary invasive biometric system, in accordance with an embodiment of the present disclosure. FIG. 2 is described in conjunction with elements from FIGS. 1A and 1B. With reference to FIG. 2, there is shown an illustration 200 of an exemplary scenario of implementation of the non-invasive biometric system 100A (of FIG. 1A). The non-invasive biometric system 100A includes the computing device 102 and the scanner 104 that are connected through the communication network 106. There is further shown the identified one or more anatomical structures in an anatomical image of the target person 108, such as a first anatomical structure 202, a second anatomical structure 204, and a third anatomical structure 206.

Firstly, the processor 102A may be configured to control the scanner 104 through the communication network 106 to scan and capture the anatomical image of the target person 108, such as the anatomical image of the target person 108 as shown on the display unit 118 of the computing device 102. Thereafter, the processor 102A may be configured to identify the one or more anatomical structures, such as the first anatomical structure 202, the second anatomical structure 204, and the third anatomical structure 206 in the anatomical image of the target person 108, as shown in the display unit 118 of the computing device 102. In an example, the first anatomical structure 202 corresponds to the kidneys of the target person 108, the second anatomical structure 204 corresponds to the heart of the target person 108, and the third anatomical structure 206 corresponds to the liver of the target person 108.

In accordance with an embodiment, the processor 102A may further be configured to process the identified one or more anatomical structures to extract visual features that are further registered together in the database 102B to generate the one or more discriminative feature vectors. In an example, the subset of visual features is extracted by the processor 102A after processing the first anatomical structure 202, the second anatomical structure 204, and the third anatomical structure 206 from the one or more anatomical structures. In an example, the processor 102A may be configured to execute the algorithm to extract the subset of visual features and the positioning features. Thereafter, the processor 102A may be configured to register the visual features along with the first anatomical structure 202, the second anatomical structure 204, and the third anatomical structure 206 to generate the one or more discriminative feature vectors. In such embodiment, the processor 102A may further be configured to process the visual features into the one or more discriminative feature vectors in accordance with the posture and the external appearance of the target person 108. Moreover, the visual features are processed to be deformation-agnostic in order to form the one or more discriminative feature vectors. In other words, the processor 102A may be configured to execute the algorithm to extract the visual features with respect to the first anatomical structure 202, the second anatomical structure 204, and the third anatomical structure 206. The processor 102A further processes the visual features into the one or more discriminative feature vectors that is robust to the external body shape and pose of the target person 108. In an implementation, the processor 102A may further be configured to process the visual features in order to be deformation-agnostic to extract the features that are discriminative (e.g., feature encoding specific organ microstructures, position). In a possible embodiment, the algorithm executed by the processor 102A can be a data-driven (e.g. machine-learning) model that learned the possible deformations of the one or more anatomical structures (e.g., organs) to compensate for them to obtain the deformation-agnostic anatomical representation in order to form the one or more discriminative feature vectors.

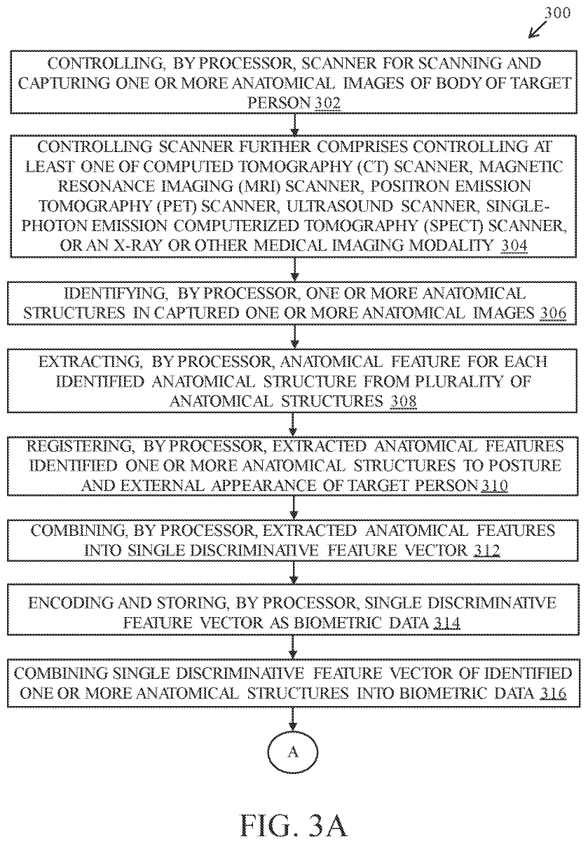

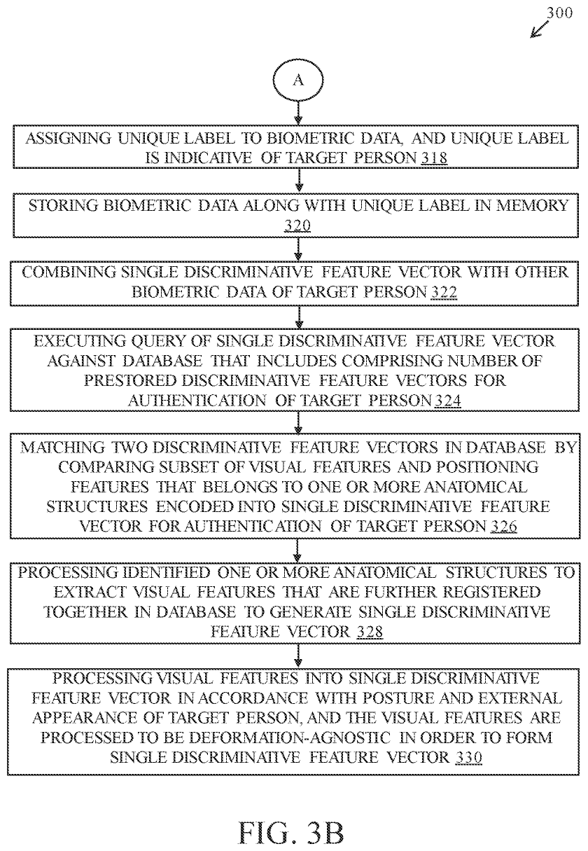

FIGS. 3A and 3B collectively is a diagram illustrating a flowchart of a method for encoding anatomical features as biometric data, in accordance with an embodiment of the present disclosure. FIGS. 3A and 3B are described in conjunction with elements from FIGS. 1A, 1B, and 2. With reference to FIGS. 3A and 3B there is shown a flowchart of a method 300 for encoding anatomical features as biometric data. The method 300 includes steps 302 to 330.

There is provided the method 300 for encoding and utilizing the anatomical features as the biometric data. The method 300 is based on the identification of discriminative inner-body features, such as organs, bones, and the like. In an example, such features can be extracted for authentication from radiographs of the target person 108.

At 302, controlling, by the processor 102A, the scanner 104 for scanning and capturing one or more anatomical images of a body of the target person 108. In an implementation, the one or more anatomical images of a body of the target person 108 that are captured by scanner 104 may be visible on the display unit 118 of the computing device.

At 304, controlling the scanner 104 further includes controlling at least one of a computed tomography (CT) scanner, a magnetic resonance imaging (MRI) scanner, a positron emission tomography (PET) scanner, an ultrasound scanner, a single-photon emission computerized tomography (SPECT) scanner, or an X-ray or other medical imaging modality. Therefore, the scanner 104 may be configured for capturing the one or more anatomical images of the body of the target person 108 based on the type of the scanner 104. In an implementation, the one or more anatomical images allow a medical personnel to view inside the body of the target person 108 without any risk of exploratory surgery.

At 306, identifying, by the processor 102A, one or more anatomical structures in the captured one or more anatomical images. In an example, the identified one or more anatomical structures may be visible on the display unit 118 of the computing device 102. In accordance with an embodiment, the identified one or more anatomical structures may be at least one of a single organ, a set of organs, a single bone, a set of bones, a liver, a spleen, or a combination of body organs and bones. Moreover, the processor 102A is configured to extract the anatomical features for the identified one or more anatomical structures.

At 308, extracting, by the processor 102A, an anatomical feature for each identified anatomical structure from the plurality of anatomical structures. In an example, the extracted anatomical feature corresponds to heartbeat, condition of the liver (e.g., stretch/compressed or affected), shape and size of bone marrow, and the like. However, the extracted anatomical features may correspond to other features without limiting the scope of the invention.

At 310, registering, by the processor 102A, the extracted anatomical features the identified one or more anatomical structures to a posture and an external appearance of the target person 108. Moreover, the extracted anatomical features may be registered to the posture and the external appearance of the target person 108, which is unique for the target person 108.

At 312, combining, by the processor 102A, the extracted anatomical features into one or more discriminative feature vectors. In an implementation, the extracted anatomical features are obtained from multiple scan results for the target person 108. Moreover, the processor 102A may be configured to detect and extract any salient anatomical structures from the multiple scan result. Thereafter, the processor 102A may be configured to combine all the extracted anatomical features into the one or more discriminative feature vectors for the target person 108.

As 314, encoding and utilizing, by the processor 102A, the one or more discriminative feature vectors as the biometric data. In an implementation, the processor 102A may be configured to use an encoding algorithm to encode and the one or more discriminative feature vectors as the biometric data.

At 316, the method 300 further comprises combining the extracted anatomical features of the identified one or more anatomical structures into the biometric data. The processor 102A may be configured to combine the extracted anatomical features of the identified one or more anatomical structures into the biometric data.

At 318, the method 300 further includes assigning a unique label to the biometric data, and the unique label is indicative of the target person 108. The processor 102A may be configured to assign the unique label to the biometric data.

At 320, the method 300 further includes storing the biometric data along with the unique label in the memory 110. The processor 102A may be configured to store the biometric data along with the unique label in the memory 110.

At 322, the method 300 further comprises combining the extracted anatomical features with other biometric data of the target person 108. The processor 102A may be used to combine the extracted anatomical features with other biometric data of the target person 108.

At 324, the method 300 further comprises executing a query of the one or more discriminative feature vectors against the database 102B that includes a number of prestored discriminative feature vectors for authentication of the target person 108. The processor 102A may be configured to execute the query of the one or more discriminative feature vectors against the database 102B.

At 326, matching at least two discriminative feature vectors in the database 102B by comparing a subset of visual features and positioning features that belong to the one or more anatomical structures encoded into the biometric data for the authentication of the target person 108. The processor 102A may be configured to match at least two discriminative feature vectors in the database 102B.

At 328, processing the identified one or more anatomical structures to extract visual features that are further registered together in the database to generate the one or more discriminative feature vectors. The processor 102A may be configured to process the identified one or more anatomical structures to extract visual features.

At 330, processing the visual features into the one or more discriminative feature vector in accordance with the posture and the external appearance of the target person 108. Moreover, the visual features are processed to be deformation-agnostic in order to form the one or more discriminative feature vector. The processor 102A may be configured to process the visual features into the one or more discriminative feature vector in accordance with the posture and the external appearance of the target person 108.

The method 300 may be used for non-invasive biometric authentication based on imaging of in-vivo body organs. The method 300 may be used for extracting and encoding of robust and distinctive anatomical features to obtain and utilize the biometric data, which is beneficial for improving the permanence and non-circumvention factors of the non-invasive biometric system 100A. As the biometric data is based on anatomical features, which is unique to each target person, thus the biometric data cannot be tampered, for example, even by plastic surgery or other means.

The steps 302 and 330 are only illustrative and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

1. A non-invasive biometric system comprising:
a processor configured to:
control a scanner configured to scan and capture one or more anatomical images of a body of a target person;
identify one or more anatomical structures in the captured one or more anatomical images;
extract anatomical features for the identified one or more anatomical structures;
register the extracted anatomical features for the identified one or more anatomical structures to a posture and an external appearance of the target person; and
encode and utilize the extracted anatomical features as biometric data.

2. The non-invasive biometric system of claim 1, wherein the scanner is at least one of: a computed tomography (CT) scanner, a magnetic resonance imaging (MRI) scanner, a positron emission tomography (PET) scanner, an ultrasound scanner, a single-photon emission computerized tomography (SPECT) scanner, or an X-ray or other medical imaging modality.

3. The non-invasive biometric system of claim 1, wherein the identified one or more anatomical structures is at least one of: a single organ, a set of organs, a single bone, a set of bones, a liver, a spleen, or a combination of body organs and bones.

4. The non-invasive biometric system of claim 1, wherein the processor is further configured to:
combine the extracted anatomical features into one or more discriminative feature vectors; and
execute a query of the one or more discriminative feature vectors against a database comprising a number of prestored discriminative feature vectors for authentication of the target person.

5. The non-invasive biometric system of claim 4, wherein the processor is further configured to match at least two discriminative feature vectors in the database by comparing a subset of visual features and positioning features that belongs to the one or more anatomical structures encoded into the biometric data for the authentication of the target person.

6. The non-invasive biometric system of claim 4, wherein the processor is further configured to process the identified one or more anatomical structures to extract visual features that are further registered together in the database to generate the one or more discriminative feature vectors.

7. The non-invasive biometric system of claim 6, wherein the processor is further configured to process the visual features into the one or more discriminative feature vectors in accordance with the posture and the external appearance of the target person, wherein the visual features are processed to be deformation-agnostic in order to form the one or more discriminative feature vectors.

8. The non-invasive biometric system of claim 1, wherein the processor is further configured to combine the extracted anatomical features of the identified one or more anatomical structures into the biometric data.

9. The non-invasive biometric system of claim 1, wherein the processor is further configured to assign a unique label to the biometric data, and wherein the unique label is indicative of the target person.

10. The non-invasive biometric system of claim 9, further comprising a memory, wherein the processor is further configured to store the biometric data along with the unique label in the memory.

11. The non-invasive biometric system of claim 1, wherein the processor is configured to combine the extracted anatomical features with other biometric data of the target person.

12. A method for encoding anatomical features as biometric data, comprising:
controlling, by a processor, a scanner for scanning and capturing one or more anatomical images of a body of a target person;
identifying, by the processor, one or more anatomical structures in the captured one or more anatomical images;
extracting, by the processor, an anatomical feature for each identified anatomical structure from the plurality of anatomical structures;
registering, by the processor, the extracted anatomical features the identified one or more anatomical structures to a posture and an external appearance of the target person; and
encoding and utilizing, by the processor, the extracted anatomical features as the biometric data.

13. The method of claim 12, wherein controlling the scanner further comprises controlling at least one of: a computed tomography (CT) scanner, a magnetic resonance imaging (MRI) scanner, a positron emission tomography (PET) scanner, an ultrasound scanner, a single-photon emission computerized tomography (SPECT) scanner, or an X-ray or other medical imaging modality.

14. The method of claim 12, further comprising:
combining the extracted anatomical features into one or more discriminative feature vectors; and
executing a query of the one or more discriminative feature vectors against a database comprising a number of prestored discriminative feature vectors for authentication of the target person.

15. The method of claim 14, further comprising matching at least two discriminative feature vectors in the database by comparing a subset of visual features and positioning features that belongs to the one or more anatomical structures encoded into the biometric data for the authentication of the target person.

16. The method of claim 14, further comprising processing the identified one or more anatomical structures to extract visual features that are further registered together in the database to generate the one or more discriminative feature vectors.

17. The method of claim 16, further comprising processing the visual features into the one or more discriminative feature vectors in accordance with the posture and the external appearance of the target person, wherein the visual features are processed to be deformation-agnostic in order to form the one or more discriminative feature vectors.

18. The method of claim 12, further comprising combining the extracted anatomical features of the identified one or more anatomical structures into the biometric data.

19. The method of claim 12, further comprising assigning a unique label to the biometric data, and wherein the unique label is indicative of the target person.

20. The method of claim 19, further comprising storing the biometric data along with the unique label in a memory.
